(19) United States
(12) Patent Application Publication
(10) Pub. No.: US 2003/0164039 A1
(43) Pub. Date: Sep. 4, 2003

(54) Tachometer with the variation of the projection light source according to the rotation speed

(76) Inventor: Jui-Yang Lo, Junghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/086,732

(22) Filed: Mar. 4, 2002

(51) Int. Cl. G01P 15/00; G01P 3/00

(52) U.S. Cl. 73/491; 73/499

(57) ABSTRACT

A tachometer with the variation of the projection light source which could set-up the critical standard speed value to provide optimum shift-shifting time, and record the fastest speed condition happened on racing at least comprising: the meter body, the micro-processor, the functional selection operation device, the memory device as well as the cylinder changeover switch; the character of this invention is to add one light source device on the circuit device inside the meter body, said light source device is comprised of a switch device, an electric-control loop and a RGB illumination device set; it utilizes the way of synchronize-light-mixing with the electric-control-loop to drive the RGB illumination device set, and by means of the program control of the microprocessor, when the rotating speed reaches the setting value, the projection light source with various color could be changed according to the setting.

### BACKGROUND OF THE INVENTION

1. Field of the invention

This invention relates to a tachometer with the variation of the projection light source according to the rotation speed, especially refers to a tachometer with the variation of the projection light source according to the rotation speed which projection light source could change various color when the rotating speed reaches the setting value by means of the program control of the microprocessor.

2. Description of the prior art

Among the auto racing which requires highly value the speed besides the factors that the racer car itself could fight against the wind, or the car body is designed to be streamline car body, one important highly valued key factor is the rotating speed of the engine; except for the acute feeling and the smart technology the auto racer himself owns, one can perform the shift switch at suitable engine rotation speed is the major factor that this racer car could gain maximum power as well as racing speed.

Thus, it is often seen that on racing, when the car is speeding up from the start point, it is often that the auto racer should switch his gear shift several times to speed-up rapidly and has the lead in the racing; however, on rapidly switching his gear shift, the rotation speed varies rapidly as well, so it is a very important topic how to make the racers whose eyes are watching their front vision easily grasp the right now rotation speed.

So, the racers should be in fine training environment except for relying on their good driving skill. Thus the maximum purpose of this invention is to simulate the car speed on racing, the racing condition, the car situation or by using other auxiliary equipments to achieve the above-mentioned effect so that the racer could grasp the rotation speed of his racer car at all times on racing and immediately switch his shift on his optimum timing.

From this we know that there still are many insufficiencies for the above-mentioned traditional object which is not a fine design and requires to be bettered.

The inventor of this invention thinks to innovate and create due to each insufficiency derivates from the above-mentioned rotation tachometer and studied for many years and finally he completes research the tachometer with the variation of the projection light source of this invention.

### SUMMARY OF THE INVENTION

The purpose of this invention is to provide a tachometer with the variation of the projection light source which could utilize the electric-controlled-loop to synchronize-light-mixing to drive the RGB illumination device set, the user could switch each color light source such as red, green, blue, yellow, indigo-blue, purple, white through the switch device, and by the control of the micro-processor program, the color of the light source could change one light source color according to the rotation speed such as 1000 RPM or 500 RPM so that when the user is driving with high-speed, he could recognize the right-now rotation-speed condition just through the light source with various color.

Another purpose of this invention is to provide a tachometer with the variation of the projection light source, which has one memory mode, when the user is setting the corresponding color light source of each rotation speed, this device will memorize all the default values so when the tachometer is being reset or being re-initiated, said corresponding color should not be reset again.

The tachometer with the variation of the projection light source of which it could achieve the above-mentioned purpose of the invention is to add a light source device in the circuit device inside the meter body, said light source device comprises:

A switch device, which could output a switch signal or a set-up signal to the electric-control loop;

An electric-control loop, which is used to receive the control signal input by the microprocessor in the circuit device of the rotating tachometer, it also could be used to receive the switch signal or the set-up signal in the switch device, and it has the function of integrating the memory signal and it outputs to drive the RGB illumination device set;

A RGB illumination device set, which are settled on the proper position inside the meter body respectively, and it receives the driving signal input by the electric-control loop;

By means of utilizing the electric-control loop to synchronize-light-mixing to drive the RGB illumination device, and by means of the program control of the micro-processor, when the rotation speed reaches the default value, it could change the projection light source with various color according to the setting.

### BRIEF DESCRIPTION OF THE DRAWINGS

The drawings disclose an illustrative embodiment of the present invention which serves to exemplify the various advantages and objects hereof, and are as follows:

FIG. 1 is the circuit block diagram of the speed with the variation of the projection light source of this invention; and

FIG. 2 is the solid figure of said speed with the variation of the projection light source.

### DETAILED DESCRIPTION OF THE PREFERRED EMBODIMENT

Said tachometer could be set-up the critical standard rotating speed value to provide optimum shift-switch time as well as record the condition of fastest rotation speed on racing which at least comprises: a meter body which covers inside all the components; a microprocessor which is used to calculate the signal of each item of input and output to achieve the function of controlling each item of variables; a functional selection operation device which function is to set up the parameter outside and to record each reference numbers on the memory device; a memory device which is used to record the default parameter or the input signal of the rotation speed of the engine to provide optimum reference data; and a cylinder changeover switch which could be used to select the cylinder type.

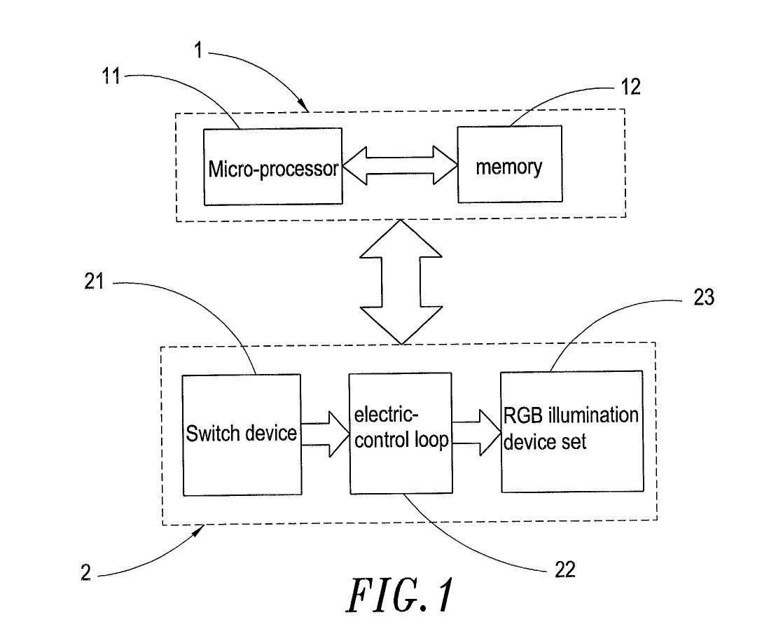

Please refer to FIG. 1, which is the circuit block diagram of the tachometer with the variation of the projection light source of this invention, from the figure we know that this invention is to add one light source device 2 on the original tachometer circuit 1, said light source device 2 comprises:

A switch device 21, which is used to output a switch signal or a setting signal onto the electric-control loop 22;

An electric-control loop 22, which is used to receive the control signal input by the micro-processor 11 in the speed circuit device, which is also used to receive the switch signal of the switch device 21 or the set-up signal, and it also has the function of integrating the memory signal, and it outputs the RGB illumination device set 23;

A RGB illumination device set 23, which is settled on the proper position inside the meter body, and it receives the driving signal input by the electric-control loop 22; and by means of the light-mixing character of the RGB illumination device wherein R=red; G=green; B=blue; R+G=yellow; G+B=indigo-blue; R+B=purple; R+G+B=white, so that the color could be changed;

It utilizes the electric-control loop 22 to drive the RGB illumination device set 23 with the way of synchronize-light-mixing, which records the speed segment as well as the color light source on the memory 12 with the default way so that the rotating tachometer has the function of various rotation speed segment and display with various color light source; whereas the user also could switch the color light source such as red, green, blue, yellow, indigo-blue, purple, white by means of the switch device 21, and by the control of the microprocessor 11 program the color light source could be setting-up according to the rotating speed segment such as one segment per 1000 RPM or one segment per 500 RPM, on practice the user first sets the speed segment and the corresponding color light source and the shift switch rotating speed value of the shift switch value is setting at 500 RPM, then when the rotating speed is between 0-1000 RPM, it is one color light source whereas when the speed is between 1000-2000 RPM, it transfers into another color light source. In accordance with this it could be imaged until the rotating speed reaches the shift switch rotating speed value which is 500 RPM. Thus the user could recognize the right-now rotating speed condition and seize the optimum shift switch timing only through various color of light source on high-speed driving.

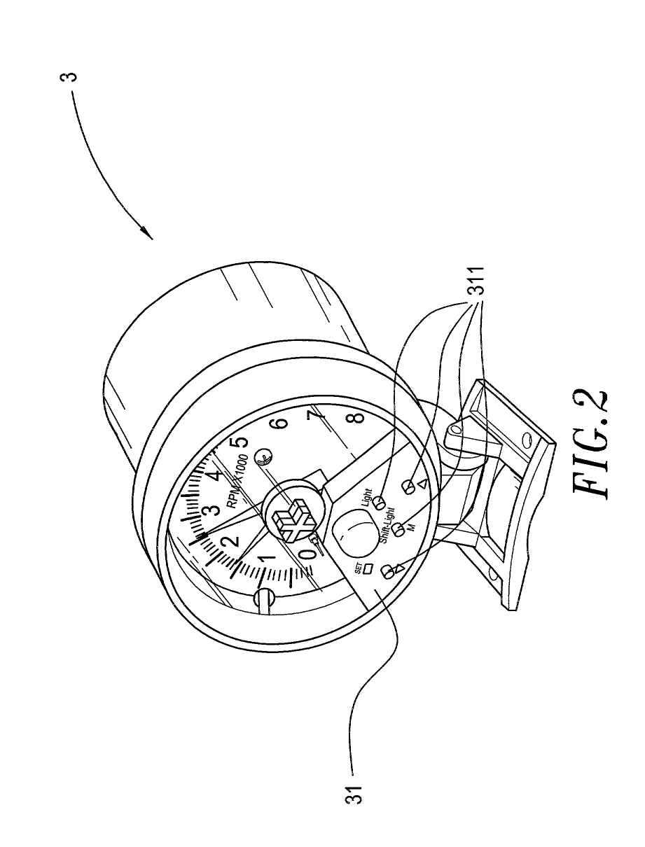

Please refer to FIG. 2, which is the solid figure of the tachometer with the variation of the projection light source of this invention. From this we know, there settles a functional selection operation panel 31 on said tachometer 3, there settles the display lamp as well as a plurality of press button 311 for control on said functional selection operation panel 31 of which said press button 311 could be expanded for usage depending on the functional requirement, the user could directly utilize the press button 311 to set-up the rotating speed region as well as the corresponding color.

The tachometer with the variation of the projection light source according to the rotation speed provided by this invention has the following advantages in comparison with other traditional technologies:

1. The tachometer with the variation of the projection light source according to the rotation speed of this invention utilizes the electric-control loop to drive the RGB illumination device set with the synchronize-light-mixing way, the user could switch the color light source such as red, green, blue, yellow, indigo-blue, purple, white through the switch device; besides, through the control of the microprocessor program, the color light source could be changed into one light source according to the rotation speed so that the user could recognize the right-now speed condition through various color light source on high-speed driving.

2. The tachometer with the variation of the projection light source according to the rotation speed of this invention has one memory mode, when the user sets up the color light source in corresponding with each segment of the rotation speed, the device will memorize all the default values, when the tachometer is to be reset or re-initiated, said corresponding color is not required to be re-selected.

3. The tachometer with the variation of the projection light source according to the rotation speed of this invention could provide the user setting-up the color light source in correspondence with each segment of the rotation speed according to his favorite or habit except for the corresponding default value pre-set in the memory to let the user feel convenient on easily recognizing the right-now speed as well he would perform gear shifting at the best time.

Many changes and modifications in the above-mentioned embodiment of this invention can, of course, be carried out without departing from the scope thereof. Accordingly, to promote the progress in science and the useful arts, the invention is disclosed and is intended to be limited only by the scope of the appended claims.

What is claimed is:

1. A tachometer with the variation of the projection light source according to the rotation speed wherein it could set-up the critical standard rotating speed value to provide optimum shift-switch time as well as record the fastest speed condition happened during racing at least comprising:
A meter body which covers the all components; a microprocessor which is used to calculate all the signals of input and output and achieve to control the function of each parameter; a functional switch selection operation device wherein the parameter is to be settled up outside and each reference data is recorded in the memory device; a memory device which records the settled parameter value or the input signal of the engine rotating speed to provide optimum reference data; and cylinder changeover switch which could be used to select the cylinder type;
which characteristic is to add a light source device on the circuit device inside the meter body, said light source device comprises:
A switch device which outputs a switch signal or a setting signal to the electric-control loop;
An electric-control loop which receives the control signal input by the microprocessor in the circuit device of the rotating tachometer and which also receives the switch signal of the switch device or the set-up signal and has the functional mode of integrating the memory signal and it outputs the driving RGB illumination device set;
A RGB illumination device set which is settled on the proper position inside the meter body and receives the driving signal input by the electric-control loop;
By means of the corresponding value of the rotating speed and the color light source preset in the memory output by the microprocessor and utilizing the electric-control loop to synchronize-light-mixing to drive the RGB illumination device so when the rotating speed reaches the set-up segment, the projection light source with various color could be changed according to the setting.

2. The tachometer as mentioned in claim 1, wherein the corresponding value of said speed and the color light source could provide the user for setting the speed segment outside with press-button and its corresponding color except for utilizing the memory to record and pre-set.

3. The tachometer as mentioned in claim 1, wherein the interval value of said speed segment could be settled according to the requirement of the user.

4. The tachometer as mentioned in claim 1, wherein said color light source provided for setting at least comprises the color such as red, green, blue, yellow, indigo-blue, purple, white.

5. The tachometer as mentioned in claim 1, wherein the functional mode of said integrating memory signal memorize all the default value after the user sets up the color light source in correspondence with each rotating speed segment, so when the rotating tachometer is being re-set or re-initiated, said corresponding color will never requires re-selected.

6. The tachometer as mentioned in claim 1, wherein there settles a functional selection operation panel on said tachometer, and there settles the display lamp as well as a plurality of press-button for control on said functional selection operational panel, the user could set-up the speed segment and the corresponding color directly by utilizing the press button.

7. The tachometer as mentioned in claim 6, wherein the press-button on said functional selection operation panel could be added according to the requirement of the function.
